(19) United States
(12) Patent Application Publication
(10) Pub. No.: US 2025/0210618 A1
(43) Pub. Date: Jun. 26, 2025

(54) METHOD OF MANUFACTURING COLLECTOR WITH ELECTRODE, POWER STORAGE DEVICE MANUFACTURING METHOD, AND POWER STORAGE DEVICE

(71) Applicant: TOYOTA JIDOSHA KABUSHIKI KAISHA, Aichi-ken (JP)

(72) Inventors: Hirokazu TAKEUCHI, Toyota-shi (JP); Yosuke SHIMURA, Nagakute-shi (JP); Tomoya MESUDA, Nisshin-shi (JP); Masato ONO, Nagoya-shi (JP); Tadashi TERANISHI, Toyota-shi (JP); Takuya ANDO, Yoshino-gun (JP)

(21) Appl. No.: 18/950,166

(22) Filed: Nov. 18, 2024

(30) Foreign Application Priority Data
Dec. 21, 2023 (JP) 2023-216263

(51) Int. Cl. H01M 4/04; H01M 4/02; H01M 50/627

(52) U.S. Cl. CPC H01M 4/0404; H01M 4/0471; H01M 50/627; H01M 2004/029

(57) ABSTRACT

A method of manufacturing a collector with an electrode of the present disclosure has a step of fabricating a collector with a coating, and a step of fabricating a collector with an electrode. In fabricating the collector with a coating, a composite material slurry is coated on a collector that is a sheet-shaped collector having plural through-holes or is a web-shaped collector having plural through-holes, and a collector with a coating, which has at least one coating of the composite material slurry, is fabricated. In fabricating the collector with an electrode, cooling air is blown onto the through-holes simultaneously with irradiating of light for heating onto the coating of the collector with a coating, and drying the coating to form a positive electrode layer or a negative electrode layer is formed, and the collector with an electrode is fabricated.

### CROSS-REFERENCE TO RELATED APPLICATION

This application is based on and claims priority under 35 USC 119 from Japanese Patent Application No. 2023-216263 filed on Dec. 21, 2023, the disclosure of which is incorporated by reference herein.

### BACKGROUND

### Technical Field

The present disclosure relates to a method of manufacturing a collector with an electrode, a power storage device manufacturing method, and a power storage device.

### Related Art

Japanese Patent Application Laid-Open (JP-A) No. 2018-195587 discloses a specific method of manufacturing an electrode (hereinafter also called “bipolar electrode”) that is used in a bipolar, non-aqueous electrolyte secondary battery (hereinafter also called “power storage device”). This manufacturing method has a step of coating a specific slurry (hereinafter also called “composite material slurry”) on a collector so as to form a coated film, and drying the coated film.

The drying step is carried out in a drying furnace 900 illustrated in FIG. 8. Plural hot air nozzles 901, plural hot air nozzles 902 and plural heaters 903 are provided within the drying furnace 900. The hot air nozzles 901 supply high-temperature hot air to the top surface side of an electrode coat film 910. The electrode coat film 910 includes a collector 912 on which a coated film 911 is formed. The hot air nozzles 902 supply low-temperature hot air to the bottom surface side of the electrode coat film 910. At the top surface side of the collector 912, the heaters 903 can uniformly supply infrared rays J to the surface of the coated film 911.

As illustrated in FIG. 8, in the drying step, at the time of drying, the infrared rays J are irradiated onto the coated film 911 that is on the collector 912, and moreover, hot air drying is carried out. In this hot air drying, the temperatures of the hot air from the hot air nozzles 902 and the hot air nozzles 901 respectively are set to specific temperatures, and the temperature distribution in the thickness direction of the electrode coat film 910 that is being dried is varied. Due thereto, the vicinity of the border between the collector 912 and the coated film 911 is maintained at a low temperature, and the vicinity of the surface of the coated film 911 is made to be a high temperature.

In the manufacturing method disclosed in JP-A No. 2018-195587, the infrared rays J are irradiated onto the surface of the coated film 911. Therefore, the coated film 911 can be dried in a short time (i.e., efficiently).

On the other hand, the infrared rays J are irradiated in radial forms from the heaters 903. Therefore, the infrared rays J supplied from the heaters 903 are irradiated onto not only coated film 911, but also onto the regions of the collector 912 where the coated film 911 is not formed (hereinafter also called “uncoated regions”). Due thereto, there is the concern that the temperature of the uncoated regions of the collector 912 will rise excessively. A temperature of the uncoated regions that has risen excessively is, for example, a temperature of 200° C. or more.

If the uncoated regions have a thermal history of high temperatures (e.g., temperatures of 200° C. or more), there is the concern that deterioration (e.g., surface oxidation) will occur at the uncoated regions. If the surfaces of the uncoated regions oxidize, the adhesion of the uncoated regions and sealing portions (i.e., resin) deteriorates, and there is the concern that the sealability of the power storage device will deteriorate. Further, if the surfaces of the uncoated regions oxidize, the conductivity of the uncoated regions becomes poor (i.e., the resistance of the uncoated regions increases), and there is the concern that the charging/discharging characteristic of the power storage device will deteriorate. Therefore, there is the need for a method of manufacturing a collector with an electrode, and a power storage device manufacturing method, that can efficiently dry a coated film of a composite material slurry while suppressing an excessive increase in temperature of the uncoated regions of the collector. There is also the need for a power storage device having excellent sealability and an excellent charging/discharging characteristic.

The present disclosure was made in view of the above-described circumstances. A topic that an embodiment of the present disclosure addresses is the provision of a method of manufacturing a collector with an electrode, and a power storage device manufacturing method, that can efficiently dry a coated film of a composite material slurry while suppressing an excessive increase in temperature of the uncoated regions of the collector. A topic addressed by another embodiment of the present disclosure is the provision of a power storage device having excellent sealability and an excellent charging/discharging characteristic.

### SUMMARY

Means for addressing the above-described topics include the following embodying aspects.
<1> A method of manufacturing a collector with an electrode of a first aspect is a method of manufacturing a collector with an electrode, the method including:
fabricating a collector with a coating that has at least one coating of a composite material slurry by coating the composite material slurry on a collector that is a sheet-shaped collector having plural through-holes or a web-shaped collector having plural through-holes; and
fabricating a collector with an electrode by blowing cooling air onto the through-holes simultaneously with irradiation of light for heating onto the coating of the collector with a coating, and drying the coating to form a positive electrode layer or a negative electrode layer.

In the present disclosure “sheet-shaped collector” indicates the collector that is included in the power storage device. A sheet-shaped collector is used at the time of manufacturing a collector with an electrode by a batch method.

A “web-shaped collector” is a belt-shaped collector that is used in order to continuously manufacture collectors with an electrode.
“Main surface” means a surface having the maximum surface area among the plural surfaces of the collector.

The light for heating can be irradiated not only onto the coating, but also onto the uncoated regions of the collector. When the light for heating is irradiated onto the uncoated regions of the collector, there is the concern that the temperature of the uncoated regions of the collector will rise excessively. A temperature of the uncoated regions that has risen excessively is, for example, greater than or equal to 200° C.

In the first aspect, cooling air is blown onto the through-holes simultaneously with the irradiation of the light for heating onto the coating of the collector with a coating. Due thereto, even though the light for heating is irradiated onto the uncoated regions of the collector, the uncoated regions of the collector can be cooled efficiently while the cooling air that passes within the through-holes is circulated. Therefore, it is difficult for the temperature of the uncoated regions of the collector to rise excessively. As a result, the method of manufacturing a collector with an electrode of the first aspect can efficiently dry the coating while suppressing an excessive increase in temperature of the uncoated regions of the collector.
<2> A method of manufacturing a collector with an electrode of a second aspect is the method of manufacturing a collector with an electrode of above <1>,
wherein the light for heating is laser light.

“Laser light” means light for heating that is emitted from a laser light source.

The directivity of laser light is greater than the directivity of light for heating that is emitted from a lamp light source (hereinafter also called “lamp light”). Therefore, it is more difficult for laser light to be irradiated onto the uncoated regions of the collector than lamp light. As a result, the method of manufacturing a collector with an electrode of the second aspect can better suppress an excessive increase in temperature of the uncoated regions of the collector.
<3> A power storage device manufacturing method of a third aspect is a power storage device manufacturing method, including:
fabricating a collector with an electrode, the collector being the web-shaped collector fabricated by the method of manufacturing a collector with an electrode of above <1> or <2>;
after implementing the fabricating of a collector with an electrode, cutting the web-shaped collector, and fabricating a bipolar electrode in which the positive electrode layer is formed on a portion of a first main surface of a sheet-shaped collector and the negative electrode layer is formed on a portion of a second main surface that is at an opposite side from the first main surface; and
fabricating a bipolar electrode with a sealing frame member by welding at least a portion of a sealing frame member to uncoated regions, at which the positive electrode layer and the negative electrode layer are not formed, of the bipolar electrode, wherein:
the plural through-holes includes a first through-hole, and
the sealing frame member has a fitting portion that fits with the first through-hole.

In the third aspect, the sealing frame member has the fitting portion that fits with the first through-hole. Due thereto, the sealing frame member can be disposed at a desired position of the sheet-shaped collector, more so than in a structure in which the sealing frame member does not have a fitting portion. Therefore, the sealing frame member can reliably close-off the plural through-holes of the sheet-shaped collector. As a result, the power storage device manufacturing method of the third aspect can manufacture the power storage device in which the occurrence of short-circuiting due to non-aqueous electrolyte liquid between adjacent unit cells is suppressed. A “unit cell” includes a positive electrode layer, a negative electrode layer, a separator and a non-aqueous electrolyte liquid.
<4> A power storage device manufacturing method of a fourth aspect is the power storage device manufacturing method of above <3>, further including:
layering the bipolar electrodes with a sealing frame member, and fabricating a stack having injection ports communicated with regions between adjacent electrodes among the bipolar electrodes; and
injecting a non-aqueous electrolyte liquid into the injection ports, and injecting the non-aqueous electrolyte liquid into the regions via the through-holes.

In the fourth aspect, the non-aqueous electrolyte liquid is injected into the injection ports, and the non-aqueous electrolyte liquid is injected into the regions via the through-holes. Due thereto, the time over which the non-aqueous electrolyte liquid is filled into the regions between adjacent bipolar electrodes is shortened. As a result, the power storage device manufacturing method of the fourth aspect can efficiently manufacture the power storage device.
<5> A power storage device of a fifth aspect is a power storage device, including:
an electrode stack including plural bipolar electrodes layered via separators;
a sealing frame forming regions between bipolar electrodes that are adjacent among the plural bipolar electrodes; and
a non-aqueous electrolyte liquid accommodated in the regions, wherein:
the bipolar electrode includes a sheet-shaped collector, a positive electrode layer formed on a portion of a first main surface of the sheet-shaped collector, and a negative electrode layer formed on a portion of a second main surface, which is at an opposite side from the first main surface, of the sheet-shaped collector,
the sheet-shaped collector has, at peripheral edges of the first main surface and the second main surface, uncoated regions at which the positive electrode layer and the negative electrode layer are not formed and to which the sealing frame is welded,
the sealing frame has injection ports communicated with the regions, and
the sheet-shaped collector includes plural through-holes at the uncoated regions.

The power storage device of the fifth aspect can be manufactured by the power storage device manufacturing method of the third aspect or the fourth aspect. Therefore, the uncoated regions of the sheet-shaped collector do not have a thermal history of high temperatures (e.g., greater than or equal to 200° C.). Namely, the surfaces of the uncoated regions of the sheet-shaped collector are not oxidized. Due thereto, the adhesion between the uncoated regions of the sheet-shaped collector and the sealing frame is excellent. Moreover, the conductivity of the uncoated regions of the sheet-shaped collector is better than in a structure in which the surfaces of the uncoated regions are oxidized. As a result, the power storage device of the fifth aspect has excellent sealability and an excellent charging/discharging characteristic.

Moreover, the sheet-shaped collector includes the plural through-holes at the uncoated regions. Due thereto, at the time of injecting the non-aqueous electrolyte liquid, the injecting can be carried out via the through-holes. As a result, in the process of manufacturing the power storage device of the fifth aspect, the injecting of the non-aqueous electrolyte liquid is completed rapidly.
<6> A power storage device of a sixth aspect is the power storage device of above <5>, wherein:
the plural through-holes includes at least one first through-hole,
the sealing frame has sealing frame members welded to the uncoated region of at least one of the first main surface or the second main surface of the sheet-shaped collector of each of the plural bipolar electrodes, and
the sealing frame member has a fitting portion that fits with the first through-hole.

In the sixth aspect, the sealing frame member has the fitting portion that fits with the first through-hole. Therefore, the sealing frame member can be disposed at a desired position of the sheet-shaped collector, more so than in a structure in which the sealing frame member does not have the fitting portion that fits with the first through-hole. Therefore, the sealing frame member can reliably close-off the plural through-holes of the sheet-shaped collector. As a result, in the power storage device of the sixth aspect, the occurrence of short-circuiting due to non-aqueous electrolyte liquid between adjacent unit cells is suppressed.
<7> A power storage device of a seventh aspect is the power storage device of above <6>, wherein the plural through-holes include:
at least two of the first through-holes, and
at least one second through-hole having a smaller diameter than a diameter of the first through-holes and in which the fitting portion is not inserted.

In the seventh aspect, the plural through-holes include at least two first through-holes. Therefore, the sealing frame member can be disposed at a desired position of the sheet-shaped collector, more so than in a structure in which the sealing frame member has one through-hole. Therefore, the sealing frame member can more reliably close-off the plural through-holes of the sheet-shaped collector. As a result, in the power storage device of the seventh aspect, the occurrence of short-circuiting due to non-aqueous electrolyte liquid between adjacent unit cells is suppressed.

In accordance with an embodiment of the present disclosure, there is provided a method of manufacturing a collector with an electrode, and a power storage device manufacturing method, that can efficiently dry a coated film of a composite material slurry while suppressing an excessive increase in temperature of the uncoated regions of the collector. In accordance with another embodiment of the present disclosure, there is provided a power storage device having excellent sealability and an excellent charging/discharging characteristic.

### BRIEF DESCRIPTION OF THE DRAWINGS

Exemplary embodiments of the present invention will be described in detail based on the following figures, wherein:

FIG. 1 is an external perspective view of a power storage device relating to an embodiment of the present disclosure;

FIG. 2 is a cross-sectional view along line II-II of FIG. 1;

FIG. 3 is a front view of a sheet-shaped collector relating to the embodiment of the present disclosure;

FIG. 4 is a front view of a bipolar electrode with a sealing frame member relating to the embodiment of the present disclosure;

FIG. 5 is a cross-sectional view along line V-V of FIG. 4;

FIG. 6 is a drawing for explaining a first drying step relating to the embodiment of the present disclosure;

FIG. 7 is a drawing for explaining a second drying step relating to the embodiment of the present disclosure; and

FIG. 8 is a schematic drawing of a conventional drying device.

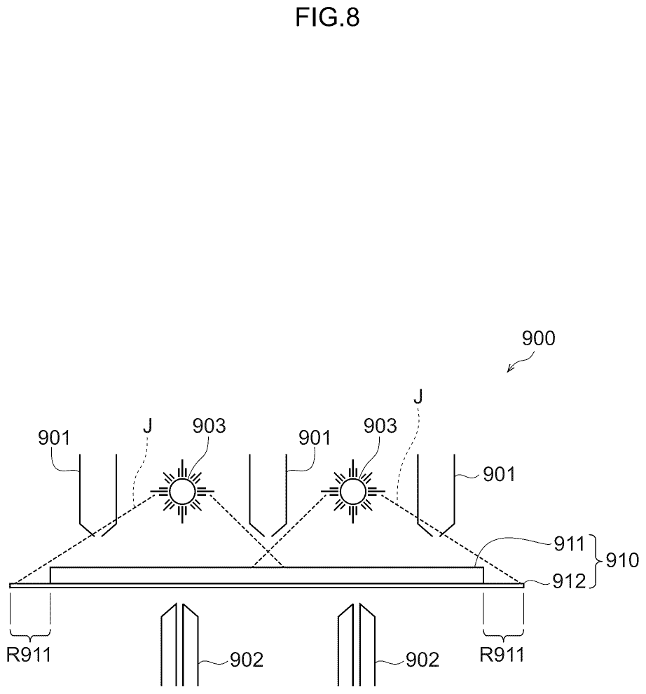

### DETAILED DESCRIPTION

In the present disclosure, numerical ranges expressed by using “-” mean ranges in which the numerical values listed before and after the “-” are included as the minimum value and maximum value, respectively. In numerical value ranges that are expressed in a stepwise manner in the present disclosure, the maximum value or the minimum value listed in a given numerical value range may be substituted by the maximum value or the minimum value of another numerical value range that is expressed in a stepwise manner. In the present disclosure, combinations of two or more preferable aspects are more preferable aspects. In the present disclosure, “step” is not only an independent step and includes steps that, even in a case in which that step cannot be clearly distinguished from another step, achieve the intended object of that step.

A power storage device manufacturing method and a power storage device relating to embodiments of the present disclosure are described hereinafter with reference to the drawings. In the drawings, the same or corresponding portions are denoted by the same reference numerals, and description is not repeated.

### (1) Power Storage Device Manufacturing Method

The power storage device manufacturing method of the present disclosure is a method that manufactures a power storage device 1. The power storage device manufacturing method of the present disclosure includes a step of fabricating a collector with an electrode, a cutting step, a first electrode fabricating step, a second electrode fabricating step, a first final end electrode fabricating step, a second final end electrode fabricating step, a stack fabricating step, a temporarily fixed body fabricating step, a pressure-reducing step, an injecting step, and a welding step.

The step of fabricating a collector with an electrode, the cutting step, the first electrode fabricating step, the second electrode fabricating step, the stack fabricating step, the temporarily fixed body fabricating step, the pressure-reducing step, the injecting step, and the welding step are carried out in that order. The first final end electrode fabricating step and the second final end electrode fabricating step are carried out before the stack fabricating step is carried out.

In the present embodiment, a reel-to-reel device is used in the step of fabricating a collector with an electrode.

### (1.1) Power Storage Device

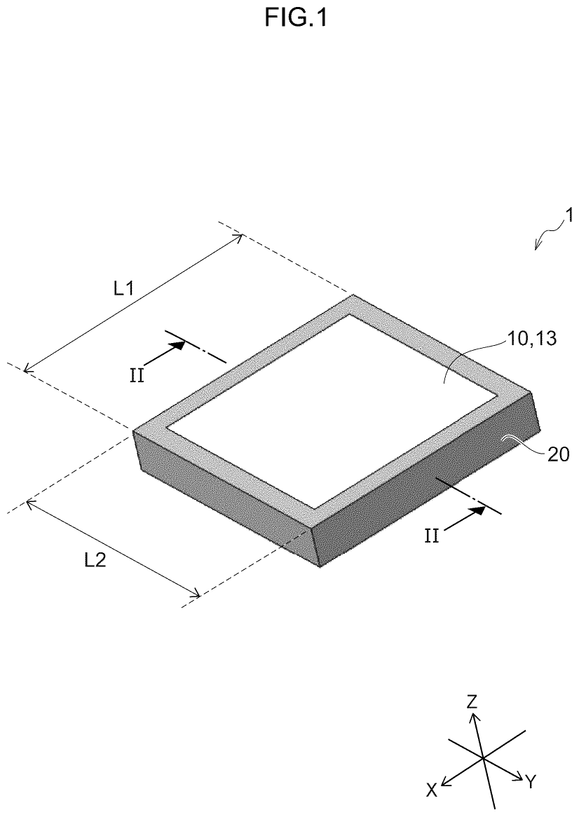

As illustrated in FIG. 1, the power storage device 1 is a rectangular parallelopiped shaped object. The power storage device 1 has an electrode stack 10, a sealing frame 20 and a non-aqueous electrolyte liquid (not illustrated). The sealing frame 20 seals the peripheral side surfaces of the electrode stack 10. The power storage device 1 is sealed by an exterior body (not illustrated) that is a known laminate film that blocks moisture.

In the present embodiment, the longitudinal direction of the main surface of the power storage device 1 is defined as the X-axis direction. The short-side direction of the main surface of the power storage device 1 is defined as the Y-axis direction. The thickness direction of the power storage device 1 is defined as the Z-axis direction. The X-axis, the Y-axis and the Z-axis are perpendicular to one another. The Z-axis direction and the gravitational direction are parallel. These directions do not limit the orientation of the power storage device of the present disclosure at the time of use thereof.

Length L1 (see FIG. 1) of the power storage device 1 along the X-axis direction and length L2 (see FIG. 1) along the Y-axis direction respectively may exceed 1 m.

### (1.1.1) Electrode Stack

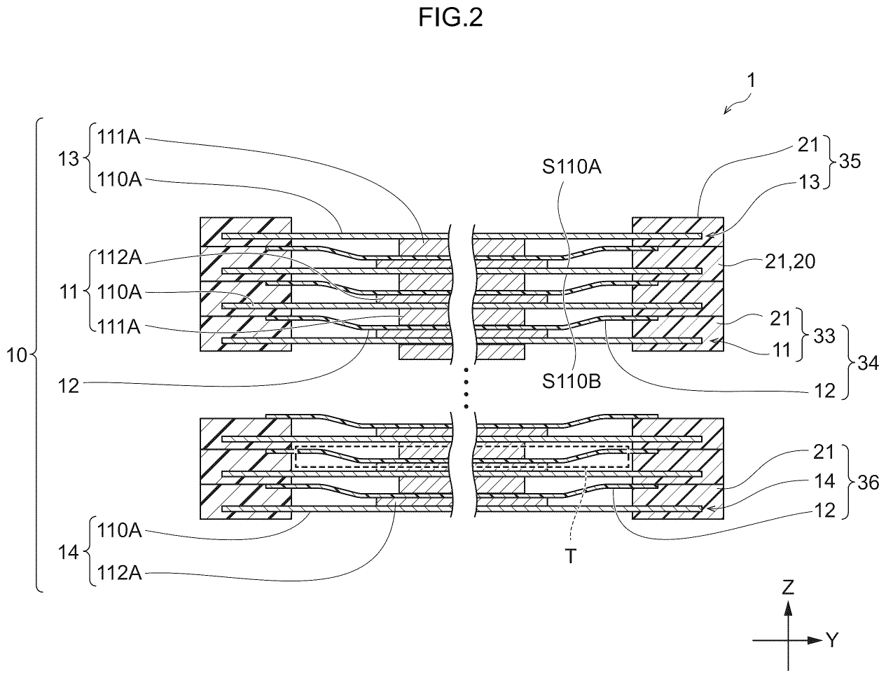

The electrode stack 10 is a rectangular parallelopiped shaped object. The electrode stack 10 includes plural bipolar electrodes 11 that are layered in the Z-axis direction via separators 12. In detail, as illustrated in FIG. 2, the electrode stack 10 has the plural bipolar electrodes 11, the plural separators 12, a positive electrode layer side final end electrode 13, and a negative electrode layer side final end electrode 14. The plural bipolar electrodes 11 and the plural separators 12 are layered alternately along the Z-axis direction. The positive electrode layer side final end electrode 13 is layered via the separator 12 on the bipolar electrode 11 that is positioned the furthest toward one side in the layering direction (the Z-axis direction positive direction side) of the plural bipolar electrodes 11. The negative electrode layer side final end electrode 14 is layered via the separator 12 on the bipolar electrode 11 that is positioned the furthest toward another side in the layering direction (the Z-axis direction negative direction side) of the plural bipolar electrodes 11.

### (1.1.1.1) Bipolar Electrodes

The bipolar electrode 11 has a sheet-shaped collector 110A (hereinafter also called “collector 110A”), a positive electrode layer 111A and a negative electrode layer 112A. The positive electrode layer 111A forms a portion of a second main surface S110B of the collector 110A. The negative electrode layer 112A forms a portion of a first main surface S110A of the collector 110A. The bipolar electrode 11 may have a known structure.

The collector 110A supplies current to the positive electrode layer 111A and the negative electrode layer 112A during charging or discharging of the power storage device 1. Metal foils, conductive resin materials and conductive inorganic materials are examples of the material of the collector 110A. Examples of the metal foils are aluminum foil, copper foil, nickel foil, titanium foil, and stainless steel foil. Examples of conductive resin materials are resins in which a conductive filler has been added as needed to a conductive polymer material or a non-conductive polymer material. Coating layers may be formed on the surfaces of the collector 110A. The coating layers may be formed by a known method (e.g., plating or spray coating). The thickness of the collector 110A may be 1 μm-100 μm.

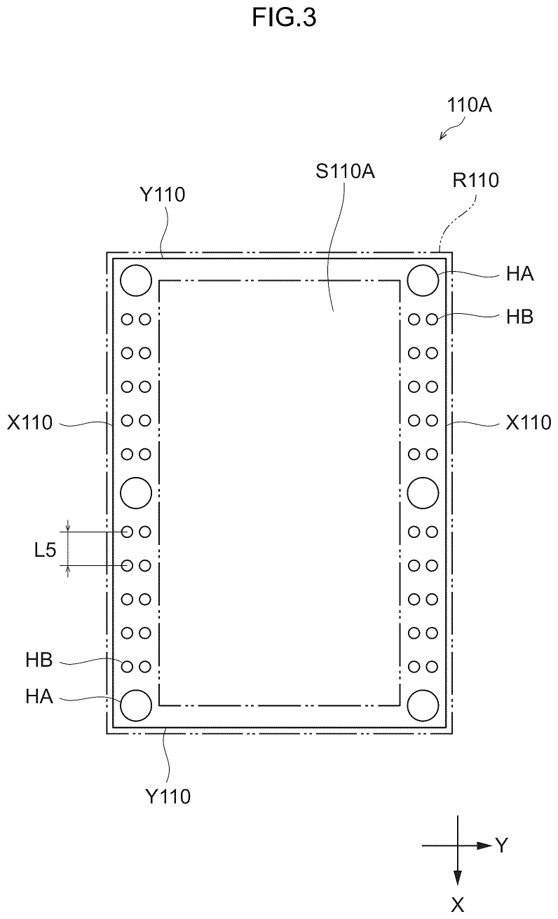

As illustrated in FIG. 3, as seen in a plan view, the collector 110A has a pair of first sides X110 extending in the X-axis direction, and a pair of second sides Y110 extending in the Y-axis direction. Namely, the collector 110A is rectangular as seen in a plan view. As illustrated in FIG. 3, the collector 110A has uncoated regions R110 at the peripheral edges of the first main surface S110A and the second main surface S110B. The positive electrode layer 111A and the negative electrode layer 112A are not formed at the uncoated regions R110. At the power storage device 1, the sealing frame 20 is welded to the uncoated regions R110.

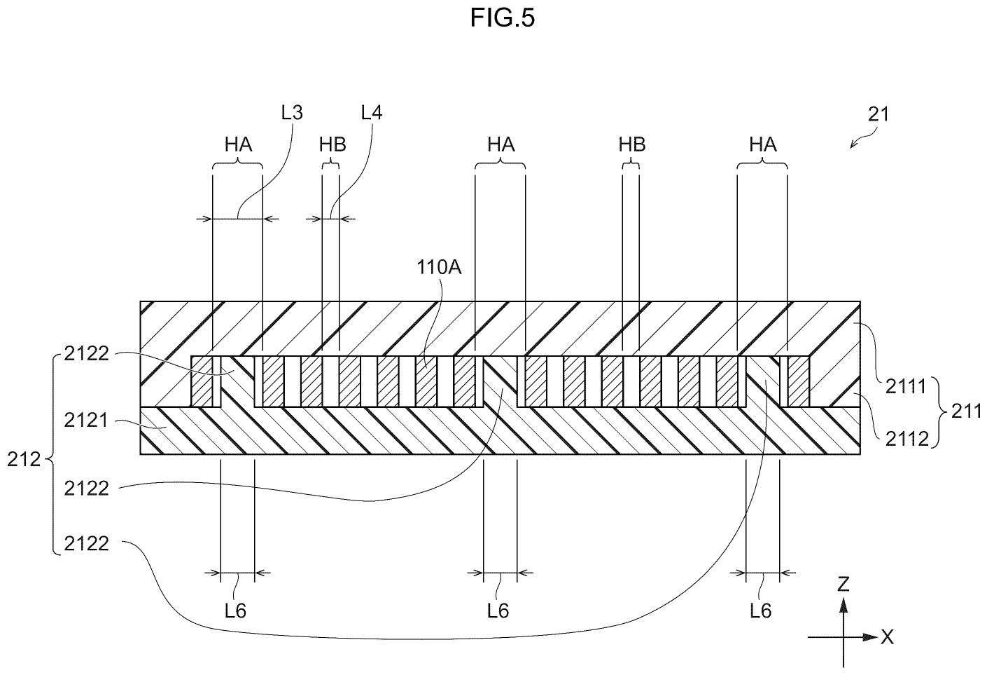

The collector 110A includes plural through-holes H at the uncoated regions R110. In the present embodiment, the shape of the through-holes H is circular. In the present embodiment, the plural through-holes H are formed along the X-axis direction in the portions of the uncoated regions R110 that are at the both Y-axis direction sides of the collector 110A. In the present embodiment, the plural through-holes H are six first through-holes HA and 40 second through-holes HB. The second through-holes HB have a smaller diameter L4 (see FIG. 5) than a diameter L3 (see FIG. 5) of the first through-holes HA. The diameter L3 of the first through-holes HA is 2 mm for example. The diameter L4 of the second through-holes HB is less than 55 μm for example. The plural second through-holes HB are disposed at a uniform interval L5 (see FIG. 3) along the X-axis direction. The interval L5 of the second through-holes HB is greater than or equal to 5.7 mm for example.

The positive electrode layer 111A contains a positive electrode layer active material (e.g., a lithium composite metal oxide having a laminar rock salt structure, a metal oxide having a spinel structure, and a polyanion compound) that can store and release the charge carrier. The thickness (the length in the Z-axis direction) of the positive electrode layer 111A may be 2 μm-500 μm.

The negative electrode layer 112A contains a negative electrode layer active material (e.g., carbon, and compounds that can be alloyed with lithium) that can take and release the charge carrier. Examples of the carbon are natural graphite, artificial graphite, hard carbon (carbon that is hard to graphitize), and soft carbon (carbon that is easy to graphitize). Examples of artificial graphite are highly oriented graphite and mesocarbon microbeads. Examples of elements that can be alloyed with lithium are silicon and tin. The thickness (the length in the Z-axis direction) of the negative electrode layer 112A may be 2 μm-500 μm. The thickness of the negative electrode layer 112A may be the same as or may be different than the thickness of the positive electrode layer 111A.

The positive electrode layer and the negative electrode layer may respectively further contain, as needed, a conduction assistant for improving the electron conductivity, a binder, an electrolyte supporting salt (lithium salt) for improving the ion conductivity, a polymer electrolyte, and additives (e.g., trifluoropropylene carbonate, and a filler that serves as a reinforcing agent). Examples of the conduction assistant are carbon nanofibers, acetylene black, carbon black, and graphite. Examples of the binder are fluorine-containing resins (polyvinylidene fluoride, polytetrafluoroethylene, fluororubber), thermoplastic resins (e.g., polypropylene, polyethylene), imide resins (e.g., polyimide, polyamide-imide), alkoxysilyl group-containing resins, acrylic resins (e.g., acrylic acid, methacrylic acid), styrene-butadiene rubber (SBR), carboxymethyl cellulose, alginates (e.g., sodium alginate, ammonium alginate), water-soluble cellulose ester crosslinked bodies, and starch-acrylic acid graft polymer. A single one of or plural types of these binders can be used.

### (1.1.1.2) Separator

The separator 12 maintains the interval between the positive electrode layer 111A and the negative electrode layer 112A so as to prevent the occurrence of short-circuiting due to contact, and allows passage of the charge carrier (e.g., lithium ions). The peripheral edge of the separator 12 is welded to the sealing frame 20, and the separator 12 is held by the sealing frame 20. Examples of the separator 12 are a porous sheet and a non-woven fabric. Examples of the material of the porous sheet are polyolefin (polypropylene, polyethylene) and polyester. Examples of the material of the non-woven fabric are polypropylene, polyethylene terephthalate and methyl cellulose. The separator 12 may be a known structure.

### (1.1.1.3) Positive Electrode Layer Side Final End Electrode

The positive electrode layer side final end electrode 13 has the collector 110A and the positive electrode layer 111A. The positive electrode layer 111A is formed at the second main surface S110B of the collector 110A. The positive electrode layer side final end electrode 13 may be a known structure.

### (1.1.1.4) Negative Electrode Layer Side Final End Electrode

The negative electrode layer side final end electrode 14 has the collector 110A and the negative electrode layer 112A. The negative electrode layer 112A is formed at the first main surface S110A of the collector 110A. The negative electrode layer side final end electrode 14 may be a known structure.

### (1.1.2) Sealing Frame

The sealing frame 20 forms regions T between the adjacent bipolar electrodes 11 among the plural bipolar electrodes 11. The positive electrode layer 111A, the negative electrode layer 112A and the separator 12 are accommodated in the region T in a state of being contained in the non-aqueous electrolyte liquid. The sealing frame 20 prevents the non-aqueous electrolyte liquid accommodated in the regions T from leaking-out to the exterior. The sealing frame 20 can prevent penetration of moisture into the regions T from the exterior of the power storage device 1. The sealing frame 20 has injection ports (not illustrated), and the injection ports are communicated with the regions T.

The sealing frame 20 is an angular-tube-shaped object that is rectangular in cross-section. The sealing frame 20 has plural sealing frame members 21. Among the plural sealing frame members 21, the sealing frame members 21 that are adjacent to one another contact one another directly. At least a portion of the boundary surface between the adjacent sealing frame members 21 is welded.

### (1.1.2.1) Sealing Frame Member

The sealing frame member 21 is an angular-tube-shaped object that is rectangular in cross-section. In the present embodiment, the sealing frame members 21 are welded to the uncoated regions R110 of the first main surfaces S110A and the second main surfaces S110B of the respective collectors 110A of the plural bipolar electrodes 11. The sealing frame members 21 are welded to the plural through-holes H. Namely, the plural through-holes H are closed-off by the sealing frame members 21 such that the non-aqueous electrolyte liquid does not flow within the plural through-holes H.

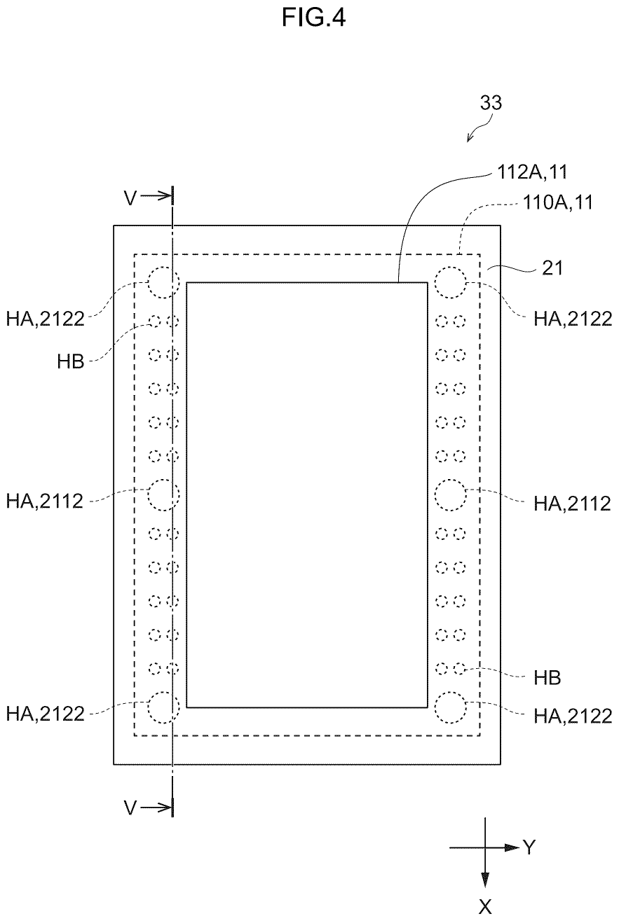

FIG. 4 is a front view of a bipolar electrode 33 with a sealing frame member. As will be described later, the bipolar electrode 33 with a sealing frame member is a part of the power storage device 1. The bipolar electrode 33 with a sealing frame member has the bipolar electrode 11 and the sealing frame member 21. The sealing frame member 21 is welded to the uncoated regions R110 of the first main surface S110A and the second main surface S110B of the collector 110A of the bipolar electrode 11. FIG. 5 is a cross-sectional view along line V-V of FIG. 4.

As illustrated in FIG. 5, the sealing frame member 21 has a first sealing frame member part 211 and a second sealing frame member part 212. The first sealing frame member part 211 and the second sealing frame member part 212 are welded together. The first sealing frame member part 211 has a flat-plate-shaped main body 2111 and a peripheral wall portion 2112. The peripheral wall portion 2112 is positioned at the peripheral edge of the flat-plate-shaped main body 2111, and protrudes-out toward the Z-axis negative direction from the flat-plate-shaped main body 2111.

The second sealing frame member part 212 has a flat-plate-shaped main body 2121 and six second fitting portions 2122. The six second fitting portions 2122 are positioned at positions corresponding to the six first through-holes HA, respectively. The second fitting portions 2122 protrude-out toward the Z-axis positive direction from the flat-plate-shaped main body 2121. The six second fitting portions 2122 fit with the corresponding first through-holes HA, respectively. The second sealing frame member part 212 does not fit with any of the plural second through-holes HB. The shape of the second fitting portion 2122 is solid cylindrical for example, and diameter L6 (see FIG. 5) of the second fitting portion 2122 is 1 mm for example.

Examples of the material of the sealing frame member 21 are polyethylene, polystyrene, acrylonitrile-butadiene-styrene copolymer synthetic resin (ABS resin), modified polypropylene, and acrylonitrile-styrene resin.

### (1.1.3) Non-Aqueous Electrolyte Liquid

The non-aqueous electrolyte liquid is accommodated in the regions T. The non-aqueous electrolyte liquid may contain a non-aqueous solvent and a lithium salt. Examples of the lithium salt are LiClO₄, LiAsF₆, LiPF₆, LiBF₄, LiCF₃SO₃, LiN(FSO₂)₂ and LiN(CF₃SO₂)₂. Examples of the non-aqueous solvent are cyclic carbonates, cyclic esters, chain carbonates, chain esters, and ethers. The non-aqueous electrolyte liquid may contain additives (e.g., lithium bis(oxalato)borate).

### (1.1.4) Applications

The power storage device 1 can be used as the power source of an electric four-wheel vehicle, an electric two-wheel vehicle, a portable device or a power storage system. Examples of electric four-wheel vehicles are BEVs (Battery Electric Vehicles), PHEVs (Plug-in Hybrid Electric Vehicles), and HEVs (Hybrid Electric Vehicles). Examples of electric two-wheel vehicles are electric motorcycles and electric assist bicycles. Examples of portable devices are smartphones, tablet computers, notebook computers, electric tools, and video cameras. Examples of power storage systems are household power storage systems, industrial power storage systems, and ESSs (Energy Storage Systems).

### (1.2) Step of Fabricating Collector With an Electrode

A collector with an electrode is fabricated in the step of fabricating a collector with an electrode. At the collector with an electrode, the positive electrode layer 111A is formed on a portion of a first main surface S100A of a web-shaped collector 110B (hereinafter also called “collector 110B”) that includes the plural through-holes H, and the negative electrode layer 112A is formed on a portion of the second main surface S110B.

In detail, the step of fabricating a collector with an electrode has a first coating step, a first drying step, a second coating step and a second drying step. The first coating step, the first drying step, the second coating step and the second drying step are carried out in that order.

### (1.2.1) First Coating Step

In the first coating step, a positive electrode composite material slurry is intermittently coated on the collector 110B, and a collector 31 with a first coating is fabricated. The collector 31 with a first coating has the collector 110B and plural coatings 111B of the positive electrode composite material slurry. The plural coatings 111B of the positive electrode composite material slurry are disposed intermittently along the longitudinal direction of the collector 110B, on the second main surface S110B of the collector 110B. The positive electrode composite material slurry is an example of the composite material slurry.

The web-shaped collector 110B has a structure similar to that of the sheet-shaped collector 110A, except that the web-shaped collector 110B is not cut into sheet shapes.

The positive electrode composite material slurry contains the structural materials of the positive electrode layer 111A, and a solvent. The solvent may be a known aqueous solvent, or may be a known organic solvent. Examples of aqueous solvents are water, and liquid mixtures of water and an alcohol (e.g., ethyl alcohol, methyl alcohol, isopropyl alcohol). Examples of organic solvents are N-methyl-2-pyrrolidone, dimethylformamide, dimethylacetamide, methylformamide, cyclohexane, and hexane. It suffices for the solvent to be a known solvent.

The coating method is not particularly limited, and a known method suffices therefor. Examples of the coating method are screen printing, electrostatic spray coating, inkjet methods, doctor blade coating, spray coating and flow coating. The positive electrode composite material slurry may be coated onto the collector 110B that is being conveyed, and the plural coatings 111B of the positive electrode composite material slurry may be formed continuously on the second main surface S110B of the collector 110B.

The method of forming the plural through-holes H of the collector 110B is not particularly limited, and a known method suffices therefor. Examples of the method of forming the plural through-holes H are laser machining, end milling, punching and etching.

### (1.2.2) First Drying Step

In the first drying step, cooling air F is blown-out onto the plural through-holes H simultaneously with the irradiating of laser light G onto the coatings 111B of the collector 31 with a first coating, and drying the coating 111B to form the positive electrode layers 111A are formed, and the collector with a positive electrode is fabricated. The collector with a positive electrode has the collector 110B and the plural positive electrode layers 111A. The plural positive electrode layers 111A are disposed intermittently along the longitudinal direction of the collector 110B on the second main surface S110B of the collector 110B. The collector with a positive electrode is an example of the collector with an electrode.

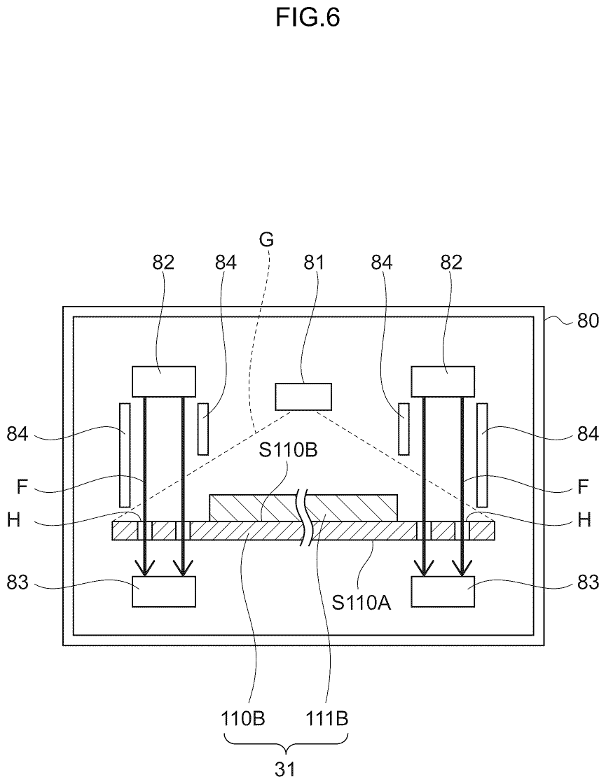

In the present embodiment, the first drying step is carried out within drying furnace 80 illustrated in FIG. 6. The drying furnace 80 has a laser light source 81, plural air supplying portions 82, plural exhaust portions 83, plural airflow regulating plates 84, and a conveying device (not illustrated). The laser light source 81, the plural air supplying portions 82 and the plural airflow regulating plates 84 are disposed at the second main surface S110B side (the coatings 111B side) of the collector 110B. The plural exhaust portions 83 are disposed at the first main surface S110A side of the collector 110B.

The laser light source 81 irradiates the laser light G onto the coatings 111B of the collector 31 with the first coating. From the standpoint of efficiently drying the coatings 111B, it is preferable that the irradiated amount of the laser light G is adjusted such that the temperature of the regions of the collector 110B where the coatings 111B are formed (hereinafter also called “coated regions”) becomes greater than or equal to 180° C. From the standpoint of suppressing an excessive rise in temperature of the uncoated regions, it is preferable that the temperature of the coated regions at the time of irradiating the laser light G is less than or equal to 220° C.

The wavelength of the laser light G is not particularly limited, and is selected appropriately in accordance with the materials of the positive electrode composite material slurry. It suffices for the laser light source 81 to be a known laser light source. Examples of the laser light source 81 are gas lasers (e.g., excimer lasers and CO₂ lasers), solid-state lasers (e.g., Nd:YAG lasers), and semiconductor lasers.

The air supplying portions 82 blow the cooling air F onto the plural through-holes H of the collector 110B. The temperature and wind speed of the cooling air F are selected appropriately in accordance with the irradiated amount of the laser light G, and are preferably adjusted such that the temperature of the uncoated regions of the collector 110B at the time of irradiating the laser light G is less than or equal to 160° C. From the standpoint of preventing the occurrence of deterioration (e.g., surface oxidation) of the uncoated regions, it is more preferable that the temperature of the uncoated regions of the collector 110B at the time of irradiating the laser light G is less than or equal to 120° C. The temperature of the uncoated regions of the collector 110B at the time of irradiating the laser light G may be greater than or equal to 80° C. The temperature of the cooling air F may be ordinary temperature (23° C.). It suffices for the air supplying portions 82 to have known structures.

The exhaust portions 83 discharge the cooling air F, which has passed through the through-holes H, to the exterior of the drying furnace 80. Due thereto, the vapor (e.g., the solvent of the positive electrode composite material slurry) within the drying furnace 80 can be discharged to the exterior of the drying furnace 80. Therefore, the temperature of the uncoated regions of the collector 110B at the time of irradiating the laser light G can be cooled efficiently by the cooling air F. It suffices for the exhaust portions 83 to be known structures.

The plural airflow regulating plates 84 guide the cooling air F, which has been supplied from the air supplying portions 82, to the plural through-holes H of the collector 110B. Due thereto, the temperature of the uncoated regions of the collector 110B at the time of irradiating the laser light G can be cooled efficiently by the cooling air F. It suffices for the airflow regulating plates 84 to be known structures.

The conveying device conveys the collector 31 with a first coating. The speed of conveying the collector 31 with a first coating is adjusted appropriately in accordance with the size of the collector 31 with a first coating and the type of the laser light source 81. For example, the conveying speed is 34 m/min. It suffices for the conveying device to be a known structure.

### (1.2.3) Second Coating Step

In the second coating step, a negative electrode composite material slurry is intermittently coated on the collector with a positive electrode, and a collector 32 with a second coating is fabricated. The collector 32 with a second coating has the collector 110B, the plural positive electrode layers 111A, and plural coatings 112B of the negative electrode composite material slurry. The plural positive electrode layers 111A are formed on the second main surface S110B of the collector 110B. The plural coatings 112B of the negative electrode composite material slurry are formed on the first main surface S110A of the collector 110B. The plural coatings 112B of the negative electrode composite material slurry are disposed so as to face the plural positive electrode layers 111A via the collector 110B. The negative electrode composite material slurry is an example of the composite material slurry.

The negative electrode composite material slurry contains the structural materials of the negative electrode layer 112A, and a solvent. Examples of the solvent are similar to those exemplified as the solvent of the first coating step. It suffices for the solvent to be a known solvent.

The coating method is not particularly limited, and examples thereof are similar to those exemplified as the coating methods of the first coating step. The negative electrode composite material slurry may be coated on the collector with a positive electrode that is being conveyed, and the plural coatings 112B of the negative electrode composite material slurry may be formed continuously on the first main surface S110A of the collector 110B.

### (1.2.4) Second Drying Step

In the second drying step, the cooling air F is blown-out onto the plural through-holes H simultaneously with the irradiating of the laser light G onto the coatings 112B of the collector 32 with a second coating, and drying the coating 112B to form the negative electrode layers 112A are formed, and a collector with a bipolar electrode is fabricated. The collector with a bipolar electrode has the collector 110B, the plural positive electrode layers 111A, and the plural negative electrode layers 112A. The plural positive electrode layers 111A are formed on the second main surface S110B of the collector 110B. The plural negative electrode layers 112A are formed on the first main surface S110A of the collector 110B. The plural negative electrode layers 112A are disposed so as to face the plural positive electrode layers 111A via the collector 110B.

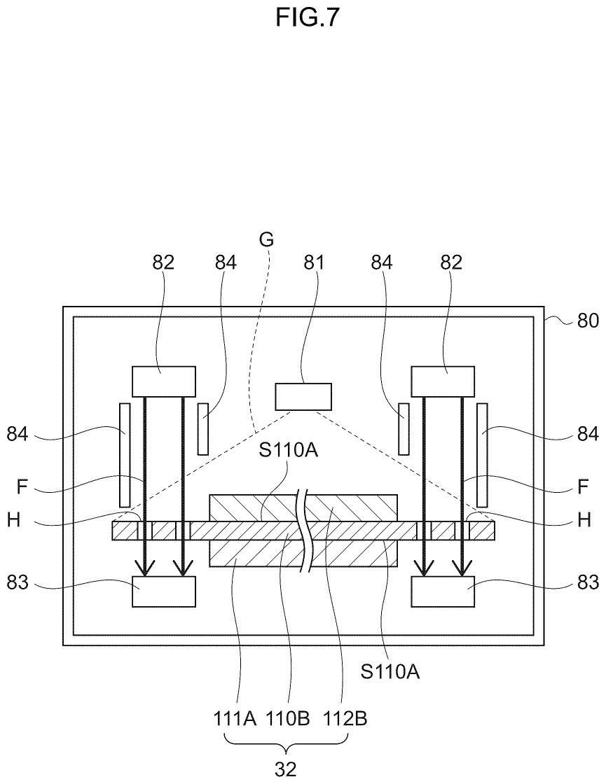

In the present embodiment, the second drying step is carried out within the drying furnace 80 illustrated in FIG. 7. The drying furnace 80 of the second drying step is structured similarly to the drying furnace 80 of the first drying step.

### (1.3) Cutting Step

In the cutting step, the web-shaped collector 110B of the collector with a bipolar electrode is cut, and the bipolar electrodes 11 are fabricated. At the bipolar electrode 11, the positive electrode layer 111A is formed at a portion of the first main surface S100A of the collector 110A, and the negative electrode layer 112A is formed at a portion of the second main surface S110B of the collector 110A. The method of cutting the web-shaped collector 110B is not particularly limited, and a known method suffices therefor.

### (1.4) First Electrode Fabricating Step

In the first electrode fabricating step, a portion of the sealing frame member 21 is welded to the collector 110A of the bipolar electrode 11, and the bipolar electrode 33 with a sealing frame member (see FIG. 2) is fabricated. The sealing frame member 21 of the bipolar electrode 33 with a sealing frame member is not welded to the plural through-holes H of the collector 110A. Namely the plural through-holes H of the collector 110A are not completely closed-off by the sealing frame member 21. The welding method is not particularly limited, and a known method suffices therefor.

### (1.5) Second Electrode Fabricating Step

In the second electrode fabricating step, the separator 12 is welded to the sealing frame member 21 of the bipolar electrode 33 with a sealing frame member, and a bipolar electrode 34 with a separator (see FIG. 2) is fabricated. The welding method is not particularly limited, and a known method suffices therefor.

### (1.6) First Final End Electrode Fabricating Step

In the first final end electrode fabricating step, a final end electrode 35 with a sealing frame member (see FIG. 2) is fabricated. The final end electrode 35 with a sealing frame member has the positive electrode layer side final end electrode 13 and the sealing frame member 21. A portion of the sealing frame member 21 is welded to the collector 110A of the positive electrode layer side final end electrode 13. The sealing frame member 21 is not welded to the plural through-holes H of the collector 110A. Namely, the plural through-holes H of the collector 110A are not completely blocked-off by the sealing frame member 21. The method of fabricating the final end electrode 35 with a sealing frame member is not particularly limited, and an example thereof is a method that is in accordance with the method of fabricating the bipolar electrode 33 with a sealing frame member (see FIG. 2).

### (1.7) Second Final End Electrode Fabricating Step

In the second final end electrode fabricating step, a final end electrode 36 with a separator (see FIG. 2) is fabricated. The final end electrode 36 with a separator has the negative electrode layer side final end electrode 14, the sealing frame member 21 and the separator 12. A portion of the sealing frame member 21 is welded to the collector 110A of the negative electrode layer side final end electrode 14. The sealing frame member 21 is not welded to the plural through-holes H of the collector 110A. Namely, the plural through-holes H of the collector 110A are not completely blocked-off by the sealing frame member 21. The method of fabricating the final end electrode 36 with a separator is not particularly limited, and an example thereof is a method that is in accordance with the method of fabricating the bipolar electrode 34 with a separator (see FIG. 2).

### (1.8) Stack Fabricating Step

In the stack fabricating step, the plural bipolar electrodes 34 with a separator are layered, and a stack having injection ports (not illustrated) that are communicated with the regions T is fabricated. In detail, the plural bipolar electrodes 34 with a separator are layered on the final end electrode 36 with a separator, and finally, the final end electrode 35 with a sealing frame member is layered thereon, and the stack is fabricated. The stack has a structure similar to that of the power storage device 1 except that, at the stack, a non-aqueous electrolyte liquid is not provided, and the plural sealing frame members 21 are not made integral, and the sealing frame members 21 are not welded to the plural through-holes H of the collectors 110A.

### (1.9) Temporarily Fixed Body Fabricating Step

In the temporarily fixed body fabricating step, the plural sealing frame members 21 of the stack are heated. Hereinafter, the stack that has been heated is called a “temporarily fixed body”. At the temporarily fixed body, the adjacent sealing frame members 21 among the plural sealing frame members 21 are welded together. Namely, the plural sealing frame members 21 are made integral. The temporarily fixed body has a structure similar to that of the power storage device 1 except that, at the temporarily fixed body, a non-aqueous electrolyte liquid is not provided, and the sealing frame members 21 are not welded to the plural through-holes H of the collectors 110A. The method of heating the sealing frame members 21 is not particularly limited, and a known method suffices therefor. Examples are laser heating, infrared ray (IR) heating, microwave heating, induction heating, hot air heating, hot plate heating, and heat rolling.

### (1.10) Pressure-Reducing Step

In the pressure-reducing step, the pressure within the plural regions T of the temporarily fixed body is reduced. Due thereto, the air in the regions T is discharged to the exterior of the temporarily fixed body. As a result, it is easy for the non-aqueous electrolyte liquid to be injected into the regions T. It suffices for the method of reducing the pressure within the regions T to be a known method.

### (1.11) Injecting Step

In the injecting step, a non-aqueous electrolyte liquid is injected into the regions T of the temporarily fixed body, and the non-aqueous electrolyte liquid is injected into the regions T via the through-holes H. Due thereto, a temporarily fixed body containing a non-aqueous electrolyte liquid is obtained. At the temporarily fixed body containing a non-aqueous electrolyte liquid, the sealing frame members 21 are not welded to the plural through-holes H of the collectors 110A. Namely, the plural regions T respectively is communicated with one another via the plural through-holes H. Therefore, when the non-aqueous electrolyte liquid is injected into the injection ports of the temporarily fixed body, the non-aqueous electrolyte liquid passes through the through-holes H and can move into the regions T. The temporarily fixed body containing a non-aqueous electrolyte liquid has a structure similar to that of the power storage device 1 except that, at the temporarily fixed body containing a non-aqueous electrolyte liquid, the sealing frame members 21 are not welded to the plural through-holes H of the collectors 110A.

### (1.12) Welding Step

In the welding step, the plural sealing frame members 21 of the temporarily fixed body containing a non-aqueous electrolyte liquid are heated, and the sealing frame 20, at which the sealing frame members 21 are welded to the plural through-holes H, is formed. The power storage device 1 is thereby obtained. The method of heating the sealing frame members 21 is not particularly limited, and a known method suffices therefor. Examples are laser heating, infrared ray (IR) heating, microwave heating, induction heating, hot air heating, hot plate heating, and heat rolling.

### (1.3) Operation/Effects

As described with reference to FIG. 1 through FIG. 7, the method of manufacturing a collector with an electrode of the present embodiment has the first coating step, the first drying step, the second coating step and the second drying step.
The laser light G can be irradiated onto not only the coatings 111B, 112B, but also onto the uncoated regions R110 of the collector 110B. When the laser light G is irradiated onto the uncoated regions R110 of the collector 110B, there is the concern that the temperature of the uncoated regions R110 of the collector 110B will rise excessively. A temperature of the uncoated regions R110 that has risen excessively is, for example, greater than or equal to 200° C.
In the present embodiment, the cooling air F is blown-out onto the plural through-holes H simultaneously with the irradiation of the laser light G onto the coatings 111B, 112B. Due thereto, even though the laser light G is irradiated onto the uncoated regions R110 of the collector 110A, the uncoated regions R110 of the collector 110B can be cooled efficiently while the cooling air F that passes within the through-holes H is circulated. Therefore, it is difficult for the temperature of the uncoated regions R110 of the collector 110B to rise excessively. As a result, the method of manufacturing a collector with an electrode of the present embodiment can efficiently dry the coatings 111B, 112B while suppressing an excessive increase in temperature of the uncoated regions R110 of the collector 110B.

As explained with reference to FIG. 1 through FIG. 7, in the present embodiment, the laser light G is used as the light for heating.

The directivity of the laser light G is greater than the directivity of infrared light supplied by infrared lamps. Therefore, it is more difficult for the laser light G to be irradiated onto the uncoated regions R110 of the collector 110B than infrared light supplied from infrared lamps. As a result, the method of manufacturing a collector with an electrode of the present embodiment can further suppress an excessive increase in temperature of the uncoated regions R110 of the collector 110B.

As explained with reference to FIG. 1 through FIG. 7, the power storage device manufacturing method of the present embodiment has the step of fabricating a collector with an electrode, the cutting step and the first electrode fabricating step. The plural through-holes H include the six first through-holes HA. The sealing frame member 21 has the six fitting portions 2122 that fit with the first through-holes HA.

Due thereto, the sealing frame member 21 can be disposed at the desired position of the collector 110A more so than in a structure in which the sealing frame member 21 does not have at least two of the fitting portions 2122. Therefore, the sealing frame member 21 can reliably close-off the plural through-holes H of the collector 110A. As a result, the power storage device manufacturing method of the present embodiment can manufacture the power storage device 1 in which the occurrence of short-circuiting due to non-aqueous electrolyte liquid between adjacent unit cells is suppressed. A “unit cell” includes the positive electrode layer 111A, the negative electrode layer 112A, the separator 12 and the non-aqueous electrolyte liquid.

As described with reference to FIG. 1 through FIG. 7, the power storage device manufacturing method of the present embodiment has the stack fabricating step and the injecting step.

In the present embodiment, the sealing frame members 21 of the temporarily fixed body are not welded to the plural through-holes H. Namely, the plural regions T respectively is communicated with one another via the plural through-holes H. Therefore, when a non-aqueous electrolyte liquid is injected into the injection ports of the temporarily fixed body, the non-aqueous electrolyte liquid passes through the through-holes H and can move into the regions T. Due thereto, the time over which the non-aqueous electrolyte liquid is filled into the regions T can be shortened more so than in a structure in which the sealing frame members 21 are welded to the plural through-holes H (i.e., a structure in which the plural through-holes H of the sealing frame members 21 are reliably closed-off). As a result, the power storage device manufacturing method of the present embodiment can efficiently manufacture the power storage device 1.

As described with reference to FIG. 1 through FIG. 7, the power storage device 1 has the electrode stack 10, the sealing frame 20 and the non-aqueous electrolyte liquid. The bipolar electrode 11 includes the collector 110A, the positive electrode layer 111A and the negative electrode layer 112A. The collector 110A has the uncoated regions R110. The sealing frame 20 has the injection ports that are communicated with the regions T. The collector 110A includes the plural through-holes H at the uncoated regions R110.

The power storage device 1 can be manufactured by the power storage device manufacturing method of the present embodiment. Therefore, the uncoated regions R110 of the collector 110A do not have a thermal history of high temperatures (e.g., greater than or equal to 200° C.). Namely, the surfaces of the uncoated regions R110 of the collector 110A are not oxidized. Due thereto, the adhesion between the uncoated regions R110 of the collector 110A and the sealing frame 20 is excellent. Moreover, the conductivity of the uncoated regions R110 of the collector 110A is better than in a structure in which the surfaces of the uncoated regions R110 are oxidized. As a result, the power storage device 1 has excellent sealability and an excellent charging/discharging characteristic.
Moreover, at the time of injecting the non-aqueous electrolyte liquid, the injection can be carried out via the through-holes H. As a result, in the process of manufacturing the power storage device 1, the injecting of the non-aqueous electrolyte liquid is completed rapidly.

As described with reference to FIG. 1 through FIG. 7, at the power storage device 1, the plural through-holes H include the six first through-holes HA. The sealing frame 20 has the sealing frame members 21 that are welded to the uncoated regions R110 of the first main surfaces S110A and the second main surfaces S110B of the respective collectors 110A of the plural bipolar electrodes 11. The sealing frame 20 has the fitting portions 2122 that fit with the first through-holes HA.

The sealing frame members 21 can be disposed at the desired positions of the collectors 110A, more so than in a structure in which the sealing frame members 21 do not have the fitting portions 2122 that fit with the first through-holes HA. Therefore, the sealing frame members 21 can reliably close-off the plural through-holes H of the collectors 110A. As a result, at the power storage device 1, the occurrence of short-circuiting due to non-aqueous electrolyte liquid between adjacent unit cells is suppressed.

As described with reference to FIG. 1 through FIG. 7, the plural through-holes H include the six first through-holes HA and the 40 second through-holes HB.

The sealing frame members 21 can be disposed at the desired positions of the collectors 110A, more so than in a structure in which the sealing frame member 21 has one through-hole H. Therefore, the sealing frame members 21 can more reliably close-off the plural through-holes H of the collectors 110A. As a result, at the power storage device 1, the occurrence of short-circuiting due to non-aqueous electrolyte liquid between adjacent unit cells is suppressed.

### (2) Modified Examples

In the present embodiment, the light for heating is the laser light G, but the present disclosure is not limited to this. For example, the light for heating may be lamp light, or may be LED (Light Emitting Diode) light. “Lamp light” means light for heating that is emitted from a lamp light source. “LED light” means light for heating emitted from an LED light source.

In the present embodiment, the web-shaped collector 110B is used as the collector in the step of fabricating a collector with an electrode, but the present disclosure is not limited to this. The sheet-shaped collector 110A may be used as the collector in the step of fabricating a collector with an electrode. If the sheet-shaped collector 110A is used as the collector, the cutting step is not carried out.

In the present embodiment, the sealing frame 20 has the plural sealing frame members 21, but the present disclosure is not limited to this, and the sealing frame 20 does not have to have the plural sealing frame members 21.
In the present embodiment, the plural through-holes H include the six first through-holes HA, but the present disclosure is not limited to this. There may be two to five, or seven or more, of the plural through-holes H, or there may be one through-hole H.
In the present embodiment, the sealing frame members 21 have the fitting portions 2122 of the same number as the number of the first through-holes HA, but the present disclosure is not limited to this. The sealing frame members 21 may have a number of the fitting portions 2122 that is less than the number of the first through-holes HA. Or, the sealing frame members 21 do not have to have the fitting portions 2122.
In the present embodiment, the first sealing frame member part 211 does not have a fitting portion that fits with the first through-hole HA, but the present disclosure is not limited to this. The first sealing frame member part 211 may have a fitting portion that fits with the first through-hole HA.

In the present embodiment, the sealing frame member 21 of the bipolar electrode 33 with a sealing frame member is not welded to the plural through-holes H, but the present disclosure is not limited to this. The sealing frame member 21 of the bipolar electrode 33 with a sealing frame member may be welded to the plural through-holes H.

In the present embodiment, the plural through-holes H are formed along the X-axis direction in the portions of the uncoated regions R110 which portions are at the both Y-axis direction sides of the collector 110A. However, the present disclosure is not limited to this. The plural through-holes H may be formed along the X-axis direction in the uncoated regions R110 of one side in the Y-axis direction of the collector 110A.

Although the shape of the through-holes H in the present embodiment is circular, the present disclosure is not limited to this, and the through-holes H do not have to be circular. The shape of the through-holes H may be, for example, polygonal or an irregular shape.

In the present embodiment, a reel-to-reel device is used in the first coating step, the first drying step, the second coating step and the second drying step. However, the present disclosure is not limited to this, and a batch method may be used.

What is claimed is:

1. A method of manufacturing a collector with an electrode, the method comprising:
fabricating a collector with a coating that has at least one coating of a composite material slurry by coating the composite material slurry on a collector that is a sheet-shaped collector having a plurality of through-holes or a web-shaped collector having a plurality of through-holes; and
fabricating a collector with an electrode by blowing cooling air onto the through-holes simultaneously with irradiation of light for heating onto the coating of the collector with a coating, and drying the coating to form a positive electrode layer or a negative electrode layer.

2. The method of manufacturing a collector with an electrode of claim 1, wherein the light for heating is laser light.

3. A power storage device manufacturing method, comprising:
fabricating a collector with an electrode, the collector being the web-shaped collector fabricated by the method of manufacturing a collector with an electrode of claim 1;
after implementing the fabricating of a collector with an electrode, cutting the web-shaped collector, and fabricating a bipolar electrode in which the positive electrode layer is formed on a portion of a first main surface of a sheet-shaped collector and the negative electrode layer is formed on a portion of a second main surface that is at an opposite side from the first main surface; and
fabricating a bipolar electrode with a sealing frame member by welding at least a portion of a sealing frame member to uncoated regions, at which the positive electrode layer and the negative electrode layer are not formed, of the bipolar electrode, wherein:
the plurality of through-holes includes a first through-hole, and
the sealing frame member has a fitting portion that fits with the first through-hole.

4. The power storage device manufacturing method of claim 3, further comprising:
layering the bipolar electrodes with a sealing frame member, and fabricating a stack having injection ports communicated with regions between adjacent electrodes among the bipolar electrodes; and
injecting a non-aqueous electrolyte liquid into the injection ports, and injecting the non-aqueous electrolyte liquid into the regions via the through-holes.

5. A power storage device, comprising:
an electrode stack including a plurality of bipolar electrodes layered via separators;
a sealing frame forming regions between bipolar electrodes that are adjacent among the plurality of bipolar electrodes; and
a non-aqueous electrolyte liquid accommodated in the regions, wherein:
the bipolar electrode includes a sheet-shaped collector, a positive electrode layer formed on a portion of a first main surface of the sheet-shaped collector, and a negative electrode layer formed on a portion of a second main surface, which is at an opposite side from the first main surface, of the sheet-shaped collector,
the sheet-shaped collector has, at peripheral edges of the first main surface and the second main surface, uncoated regions at which the positive electrode layer and the negative electrode layer are not formed and to which the sealing frame is welded,
the sealing frame has injection ports communicated with the regions, and
the sheet-shaped collector includes a plurality of through-holes at the uncoated regions.

6. The power storage device of claim 5, wherein:
the plurality of through-holes includes at least one first through-hole,
the sealing frame has sealing frame members welded to the uncoated region of at least one of the first main surface or the second main surface of the sheet-shaped collector of each of the plurality of bipolar electrodes, and
the sealing frame member has a fitting portion that fits with the first through-hole.

7. The power storage device of claim 6, wherein the plurality of through-holes includes:
at least two of the first through-holes, and
at least one second through-hole having a smaller diameter than a diameter of the first through-holes and in which the fitting portion is not inserted.
